(19) United States
(12) Patent Application Publication
(10) Pub. No.: US 2021/0021463 A1
(43) Pub. Date: Jan. 21, 2021

(54) COMMUNICATION SYSTEM, SERVER AND CONTROL UNIT

(71) Applicant: HONDA MOTOR CO., LTD., Tokyo (JP)

(72) Inventor: Manabu Dobashi, Wako-shi, Saitama (JP)

(21) Appl. No.: 16/981,030

(22) PCT Filed: Mar. 29, 2018
(86) PCT No.: PCT/JP2018/013266

§ 371 Date: Sep. 15, 2020

(51) Int. Cl. H04L 12/24; H04W 4/44; B63B 79/40

(52) U.S. Cl. CPC H04L 41/082; B63B 79/40; H04W 4/44

(57) ABSTRACT

A communication system includes a server and a control unit that includes a work machine information acquisition section and a work machine information transmission section. The server includes a transmission timing update instruction section configured to transmit, to the control unit, transmission timing update information that instructs an update of a transmission timing, according to an update condition determined based on work machine information received from the control unit, and the control unit includes a transmission timing update section configured to update the transmission timing, based on the transmission timing update information transmitted from the server.

### TECHNICAL FIELD

The present invention relates to a communication system in which information on a work machine is acquired, as well as to a server and a control unit.

### BACKGROUND ART

Conventionally, a system has been proposed in which a vessel and a server are communicably configured, and various information on the vessel (a position of the vessel, an engine speed, a throttle opening degree, and the like) sensed by sensors and the like provided on the vessel is transmitted from the vessel to the server through wireless communication at preset intervals (for example, see Patent Literature 1). According to the system described in Patent Literature 1, since a state of the vessel can be monitored from a remote location, a breakdown or the like of the vessel, when occurring, can be promptly handled, and in addition, appropriate services can be provided by keeping track of usage states of various vessels.

### CITATION LIST

### Patent Literature

Patent Literature 1: U.S. Pat. No. 6,933,884 Specification

### SUMMARY OF INVENTION

### Technical Problem

In the system described in Patent Literature 1, the various information on a work machine such as the vessel is transmitted from the vessel to the server at the preset constant intervals. As the number of work machines that transmit the various information to the server increases, loads on a server side increase accordingly, and a communication failure may easily occur consequently, to possibly cause a situation where important information, such as a breakdown of the work machine, is not received by the server due to the communication failure.

The present invention is made in view of such a background, and an object of the present invention is to provide a communication system, a server, and a control unit that restrain occurrence of a situation where information on a work machine is not received by the server.

### Solution to Problem

A communication system according to an aspect of the present invention is a communication system including: a server; and a control unit including a work machine information acquisition section and a work machine information transmission section, the work machine information acquisition section being configured to acquire work machine information that is information related to a work machine, and the work machine information transmission section being configured to transmit the work machine information to the server at a predetermined transmission timing, wherein the server includes a transmission timing update instruction section configured to transmit, to the control unit, transmission timing update information that instructs an update of the transmission timing, according to an update condition determined based on the work machine information received from the control unit, and the control unit includes a transmission timing update section configured to update the transmission timing, based on the transmission timing update information received from the server.

When transmission of the work machine information to the server at the transmission timing fails, the work machine information transmission section may be configured to store the unsuccessfully transmitted work machine information in a memory, and to transmit the work machine information stored in the memory to the server at a timing different from the transmission timing.

The transmission timing update instruction section may be configured to determine, based on the work machine information, whether or not the work machine is in a state to be monitored and, when it is determined that the work machine is in the state to be monitored, to determine the update condition that shortens an interval between transmissions of the work machine information.

The transmission timing update instruction section may be configured to identify an operation condition at a time of normal operation of the work machine, based on the work machine information received during a predetermined time period, and to determine that the work machine that transmits the work machine information is in the state to be monitored if the work machine is recognized to deviate from the operation condition.

The transmission timing update instruction section may be configured to determine, based on the work machine information, whether or not the work machine is in a state not to be monitored and, when it is determined that the work machine is in the state not to be monitored, to determine the update condition that lengthens an interval between transmissions of the work machine information.

When the number of the control units that transmit the work machine information decreases to become equal to or smaller than a predetermined number, the transmission timing update instruction section may be configured to determine the update condition that shortens the lengthened interval between transmissions of the work machine information.

Next, a server according to another aspect of the present invention is a server that receives work machine information that is information related to a work machine, the work machine information being transmitted at a predetermined transmission timing from a control unit used at the work machine, the server including: a transmission timing update instruction section configured to transmit, to the control unit, transmission timing update information that instructs an update of the transmission timing, according to an update condition determined based on the work machine information transmitted from the control unit.

Next, a control unit according to still another aspect of the present invention is a control unit that includes a work machine information acquisition section and a work machine information transmission section, the work machine information acquisition section being configured to acquire work machine information that is information related to a work machine, and the work machine information transmission section being configured to transmit the work machine information to a server at a predetermined transmission timing, the control unit including: a transmission timing update section configured to update the transmission timing, according to an update condition determined based on the work machine information.

### Advantageous Effects of Invention

According to the communication system, the server, and the control unit of the aspects of the present invention, a timing of transmission of work machine information is updated according to an update condition based on the work machine information, whereby the timing of transmission of the work machine information can be appropriately set for each control unit. Accordingly, loads on the server of receiving the work machine information transmitted from a plurality of the control units can be reduced, and occurrence of a situation can be restrained where the work machine information is not received by the server.

### BRIEF DESCRIPTION OF DRAWINGS

FIG. 1 is an explanatory diagram showing a scenario of acquiring information on an outboard motor by using a communication system.

FIG. 2 is a configuration diagram of a server and a control unit of the outboard motor, which are included in the communication system.

FIG. 3 is a flowchart for the control unit and the server, related to transmission of work machine information.

FIG. 4 is an explanatory diagram of timings of retransmission when transmission of the work machine information has failed.

FIG. 5 is a flowchart for the server, related to an update of timings of transmission.

### DESCRIPTION OF EMBODIMENTS

### 1. Scenario of Acquiring Information on Outboard Motor by Using Communication System

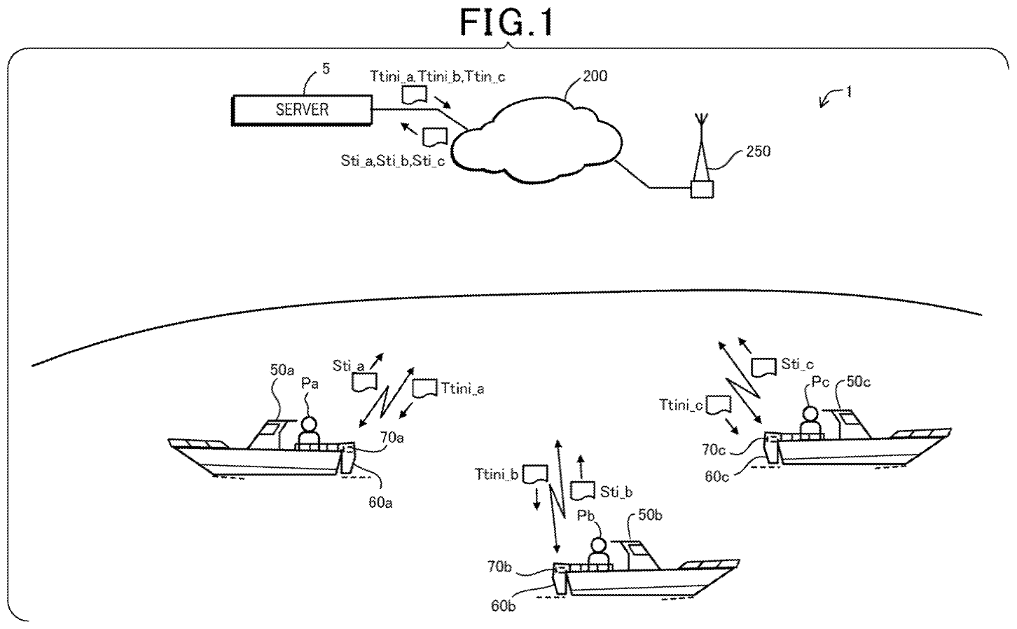

FIG. 1 shows a scenario of acquiring information on an outboard motor by using a communication system in an embodiment. Referring to FIG. 1, a communication system 1 in the present embodiment includes a server 5 and control units 70a to 70c. The control units 70a to 70c are included in outboard motors 60a to 60c aboard a plurality of vessels 50a to 50c, respectively. The control units 70a to 70c perform wireless communication with a wireless base station 250, and communication is established between the control units 70a to 70c and the server 5 via the wireless base station 250 and a communication network 200.

Each of the outboard motors 60a to 60c puts a screw (not shown) into rotating operation by using an engine (not shown) and thereby generates propelling force for the respective vessels 50a to 50c on which the outboard motors 60a to 60c are boarded. The control unit 70a, in response to an operation made by an operating person Pa aboard the vessel 50a, performs starting and stopping of the engine, control of an engine speed, control of a gear state, and the like.

The control unit 70a transmits, to the server 5, work machine information Sti_a indicating an operating state and the like of the outboard motor 60a sensed by various sensors included in the outboard motor 60a. The server 5, based on the work machine information Sti_a received from the control unit 70a, determines an update condition for timings of transmission of the work machine information Sti_a at the control unit 70a. The server 5 transmits, to the control unit 70a, update instruction information Ttini_a (including transmission timing update information according to the present invention) indicating the update condition for the timings of transmission of the work machine information Sti_a at the control unit 70a.

The control unit 70a, based on the update instruction information Ttini_a received from the server 5, updates the timings of transmission of the work machine information Sti_a. Thus, the timings of transmission of the work machine information Sti_a at the control unit 70a are updated according to the operating state of the outboard motor 60a.

Similarly, the control unit 70b transmits, to the server 5, work machine information Sti_b indicating an operating state and the like of the outboard motor 60b, and the server 5, based on the work machine information Sti_b, determines an update condition for timings of transmission of the work machine information Sti_b at the control unit 70b. The control unit 70b, based on update instruction information Ttini_b received from the server 5, updates the timings of transmission of the work machine information Sti_b.

Moreover, the control unit 70c transmits, to the server 5, work machine information Sti_c indicating an operating state and the like of the outboard motor 60c, and the server 5, based on the work machine information Sti_c, determines an update condition for timings of transmission of the work machine information Sti_c at the control unit 70c. The control unit 70c, based on update instruction information Ttini_c received from the server 5, updates the timings of transmission of the work machine information Sti_c.

In such a manner, the communication system 1 updates the timings of transmission of the work machine information Sti_a to Sti_c at the control units 70a to 70c included in the outboard motors 60a to 60c, according to the operating states of the outboard motors 60a to 60c, respectively. Thus, loads on the server 5 of receiving the work machine information Sti_a to Sti_c can be reduced, and failures in transmission of the work machine information Sti_a to Sti_c due to communication failures between the server 5 and the control units 70a to 70c can be restrained.

### 2. Configurations of Server and Outboard Motor

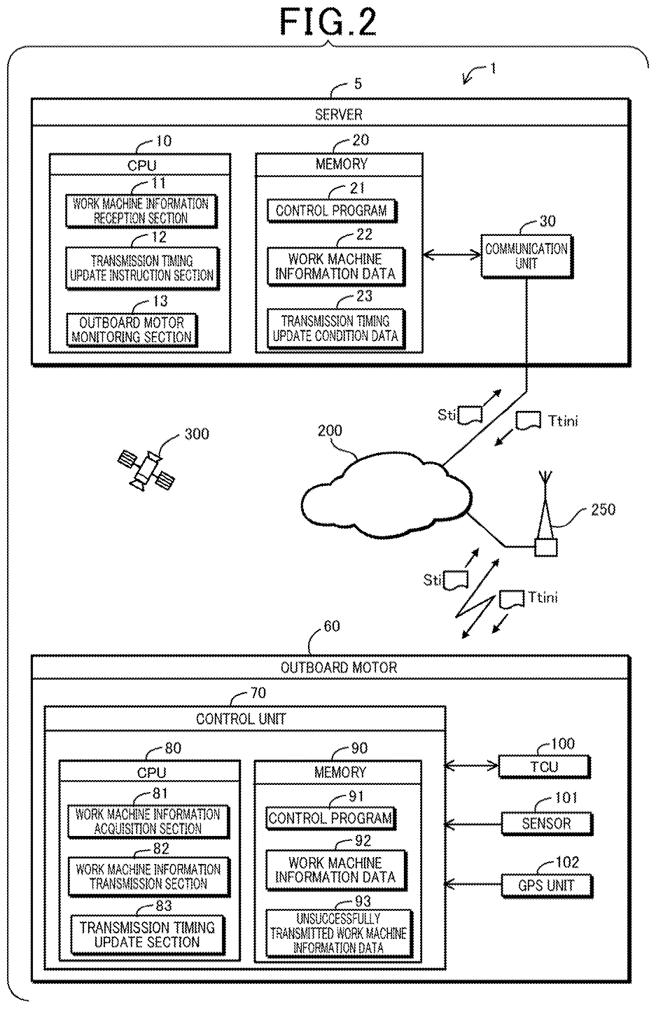

Next, referring to FIG. 2, configurations of the server 5 and the outboard motors 60a to 60c shown in FIG. 1 will be described. Since the outboard motors 60a to 60c have similar configurations and the control units 70a to 70c have similar configurations, a description hereinbelow is given by using an outboard motor 60 and a control unit 70 as representatives, and by denoting the work machine information Sti_a to Sti_c by Sti, and the update instruction information Ttini_a to Ttini_c by Ttini. As described above, the server 5 and the control unit 70 mutually communicate via the wireless base station 250 and the communication network 200.

The server 5 is a computer system including a CPU (Central Processing Unit) 10, a memory 20, a communication unit 30, and the like. The CPU 10 functions as a work machine information reception section 11, a transmission timing update instruction section 12, and an outboard motor monitoring section 13 by executing a control program 21 for controlling the server 5 stored in the memory 20.

The memory 20 stores, in addition to the control program 21, work machine information 22 in which work machine information Sti received from the control unit 70 is written, and transmission timing update condition data 23 in which an update condition for timings of transmission determined based on the work machine information Sti is written.

The work machine information reception section 11 receives, via the communication unit 30, the work machine information Sti transmitted from the control unit 70, and writes the work machine information Sti in the work machine information data 22. The transmission timing update instruction section 12 determines, based on the work machine information data 22, the update condition for the timings of transmission of the work machine information Sti at the control unit 70, and writes the determined update condition in the transmission timing update condition data 23. The transmission timing update instruction section 12 transmits update instruction information Ttini indicating the update condition for the timings of transmission, to the control unit 70 via the communication unit 30.

The outboard motor monitoring section 13 monitors an operating state of the outboard motor 60 based on the work machine information Sti written in the work machine information data 22, and transmits information prompting maintenance of the outboard motor 60 or the like to the control unit 70 via the communication unit 30 as necessary.

The outboard motor 60 includes, in addition to the control unit 70, a TCU (Telematics Communication Unit) 100 that performs wireless communication with the wireless base station 250, sensors 101 that sense the operating state of the outboard motor 60, and a GPS unit 102 that receives a signal from a GPS (Global Positioning System) satellite 300 and detects a current position of the outboard motor 60. The sensors 101 include an engine speed sensor that senses a speed of an engine included in the outboard motor 60, a throttle sensor that senses a throttle opening degree, an O₂ sensor that senses an O₂ concentration in combustion exhaust gas of the engine, and the like.

The control unit 70 is a circuit unit including a CPU 80, a memory 90, various interface circuits (not shown), and the like. The CPU 80 functions as a work machine information acquisition section 81, a work machine information transmission section 82, and a transmission timing update section 83 by executing a control program 91 for controlling the control unit 70 stored in the memory 90.

The work machine information acquisition section 81 acquires the work machine information Sti, such as the engine speed, the throttle opening degree, the O₂ concentration in the combustion exhaust gas of the outboard motor 60 sensed by the sensors 101, and the current position (latitude, longitude) of the outboard motor 60 detected by the GPS unit 102, and records the acquired work machine information Sti in work machine information data 92. The work machine information transmission section 82 transmits the work machine information Sti recorded in the work machine information data 92 to the server 5 via the TCU 100 at the predetermined timings of transmission.

The transmission timing update section 83, in response to the update instruction information Ttini received from the server 5, updates the timings of transmission of the work machine information Sti performed by the work machine information transmission section 82.

### 3. Processing for Transmitting and Receiving Work Machine Information

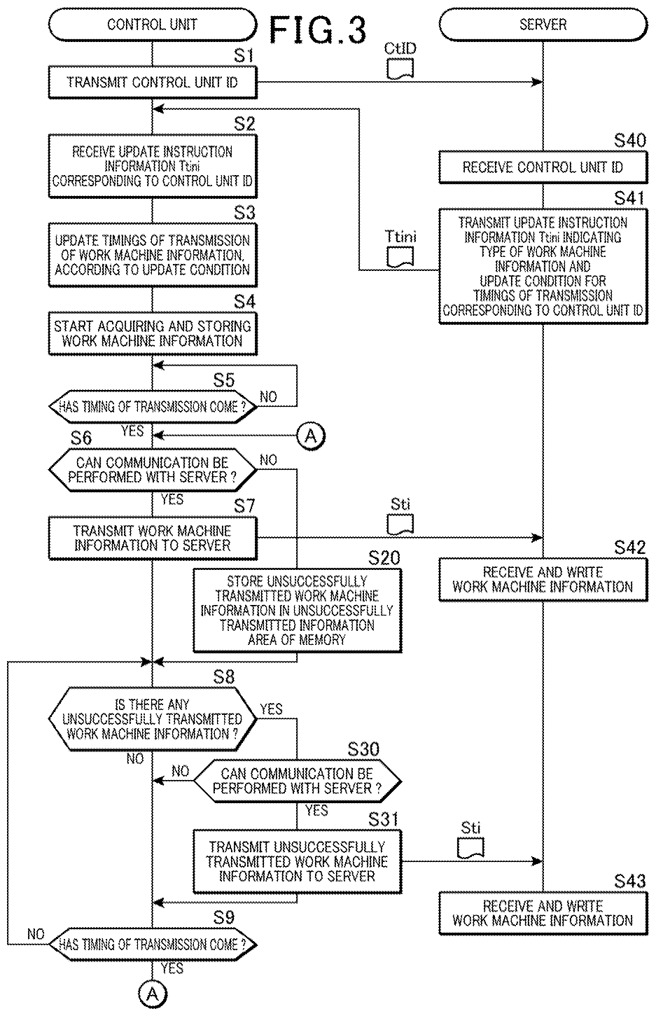

Next, processing for transmitting and receiving work machine information performed between the server 5 and the control unit 70 of the outboard motor 60 will be described by following a flowchart shown in FIG. 3.

Upon activation (when a power supply is turned on), the control unit 70 starts the processing according to the flowchart in FIG. 3. In STEP S1, the work machine information transmission section 82 of the control unit 70 transmits, to the server 5, control unit ID information CtID indicating a control unit ID that is a unique ID (identification) assigned to the control unit 70.

In STEP S40, the work machine information reception section 11 of the server 5 receives the control unit ID information CtID. In subsequent STEP S41, which is processing performed by the transmission timing update instruction section 12, the transmission timing update instruction section 12 identifies a machine type of the control unit 70 from the control unit ID recognized from the control unit ID information CtID.

Based on the machine type of the control unit 70, the transmission timing update instruction section 12 determines a type or types of the work machine information (detection values of the included sensors, or the like) to be acquired. Moreover, the transmission timing update instruction section 12 acquires the update condition for the timings of transmission at the control unit 70 recorded in association with the control unit ID in the transmission timing update condition data 23. The transmission timing update instruction section 12 transmits, to the control unit 70, the update instruction information Ttini indicating the type of the work machine information and the update condition for the timings of transmission corresponding to the control unit ID.

In STEP S2, the work machine information transmission section 82 of the control unit 70 receives the update instruction information Ttini from the server 5. In subsequent STEP S3, the work machine information transmission section 82 updates the timings of transmission of the work machine information Sti, according to the update condition indicated by the update instruction information Ttini.

In subsequent STEP S4, the work machine information acquisition section 81 of the control unit 70 starts acquiring the work machine information Sti and writing the work machine information Sti in the work machine information data 92. In subsequent STEP S5, the work machine information transmission section 82 waits for a timing of transmission to come, and advances the processing to STEP S6. In STEP S6, the work machine information transmission section 82 determines whether or not communication can be performed with the server 5.

The work machine information transmission section 82 advances the processing to STEP S7 when communication can be performed with the server 5, and advances the processing to STEP S20 when communication cannot be performed with the server 5. In STEP S7, the work machine information transmission section 82 transmits the work machine information Sti to the server 5. In STEP S42, the work machine information reception section 11 of the server 5 receives the work machine information Sti and records the work machine information Sti in the work machine information data 22 of the memory 20.

In STEP S20, the work machine information transmission section 82 records the work machine information Sti that was unsuccessfully transmitted (that was not able to be transmitted) in unsuccessfully transmitted work machine information data 93 of the memory 90, and advances the processing to STEP S8. In STEP S8, the work machine information transmission section 82 determines whether or not there is any unsuccessfully transmitted work machine information Sti (whether or not the work machine information Sti is recorded in the unsuccessfully transmitted work machine information data 93).

The work machine information transmission section 82 advances the processing to STEP S30 when there is any unsuccessfully transmitted work machine information Sti, and advances the processing to STEP S9 when there is no unsuccessfully transmitted work machine information Sti. In STEP S30, the work machine information transmission section 82 determines whether or not communication can be performed with the server 5. The work machine information transmission section 82 advances the processing to STEP S31 when communication can be performed with the server 5, and advances the processing to STEP S9 when communication cannot be performed with the server 5.

In STEP S31, the work machine information transmission section 82 transmits, to the server 5, the unsuccessfully transmitted work machine information Sti (the work machine information Sti recorded in the unsuccessfully transmitted work machine information data 93 of the memory 30), and advances the processing to STEP S9. In STEP S43, the work machine information reception section 11 of the server 5 receives the work machine information Sti and records the work machine information Sti in the work machine information data 22 of the memory 20.

In STEP S9, the work machine information transmission section 82 determines whether or not a timing of transmission has come. The work machine information transmission section 82 advances the processing to STEP S6 when a timing of transmission has come, and advances the processing to STEP S8 when a timing of transmission has not come.

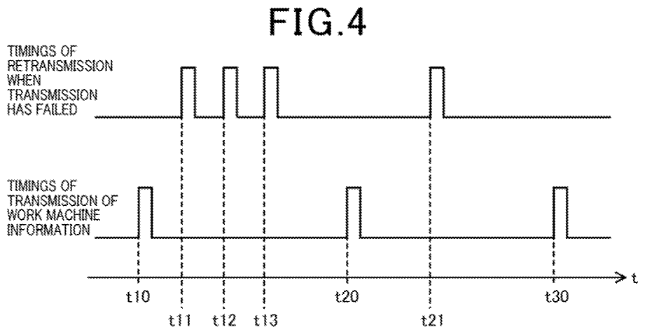

Here, FIG. 4 is a timing chart showing a case of retransmitting the unsuccessfully transmitted work machine information Sti, through the processing in STEPs S8, S9, S30, S31 in FIG. 3. In FIG. 4, timings of transmission updated in STEP S3 in FIG. 3 are shown in a lower part, and timings of retransmission of the work machine information Sti in STEP S31 are shown in an upper part, by using a common time axis t.

In the example in FIG. 4, the unsuccessfully transmitted work machine information Sti is transmitted at timings t11, t12, t13, t21, by using intervals between ordinary transmission timings t10, t20, t30. In other words, when transmission of the work machine information Sti at the transmission timing t10 has failed, retransmission of the unsuccessfully transmitted work machine information Sti is performed at t11, t12, t13 and completed before the next transmission timing t20 comes. When transmission of the work machine information Sti at the transmission timing t20 has failed, retransmission of the unsuccessfully transmitted work machine information Sti is performed at t21 and completed before the next transmission timing t30 comes.

The unsuccessfully transmitted work machine information Sti is retransmitted during the intervals between the ordinary transmission timings t10, t20, t30 as described above, whereby processing for changing, such as adding the unsuccessfully transmitted work machine information Sti to the work machine information Sti that is transmitted at the ordinary transmission timings t20, t30, can be eliminated.

### 4. Processing for Updating Timings of Transmission

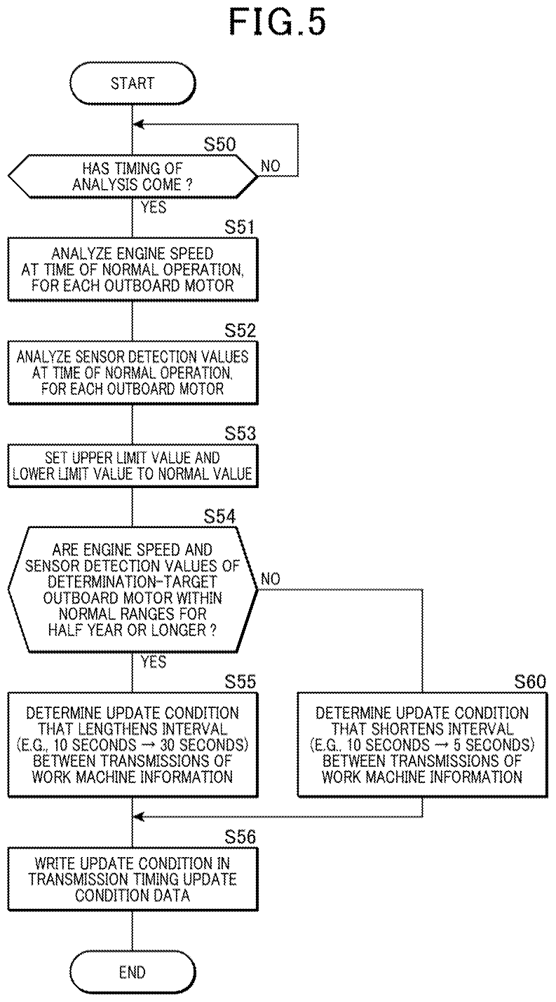

Next, processing for updating the timings of transmission of the work machine information Sti performed by the transmission timing update instruction section 12 of the server 5 will be described by following a flowchart shown in FIG. 5. In STEP S50, when a timing of analysis comes, the transmission timing update instruction section 12 advances the processing to STEP S51. Here, the timing of analysis is set, for example, once a day, at 0:00 hours local time or the like.

In STEP S51, the transmission timing update instruction section 12 analyzes the engine speed at a time of normal operation, for each outboard motor. In subsequent STEP S52, the transmission timing update instruction section 12 analyzes the sensor detection values at the time of normal operation, for each outboard motor. In STEP S53, the transmission timing update instruction section 12 sets an upper limit value and a lower limit value to a normal value of each of the engine speed and the sensor detection values, and thereby specifies respective normal ranges (an operation condition at the time of normal operation).

Here, the engine speed and the sensor detection values at the time of normal operation are extracted by withdrawing the work machine information Sti acquired on a date and at a time when no problem occurred with the outboard motor 60, among a large volume of the work machine information Sti recorded in the work machine information data 22 of the memory 20. The engine speed and the sensor detection values at the time of normal operation may be extracted by excluding one week before and after a date when a problem occurred.

In subsequent STEP S54, the transmission timing update instruction section 12 determines whether or not the engine speed and the sensor detection values of the outboard motor 60 that is a determination-target are within the normal ranges for a half year (corresponding to a predetermined time period according to the present invention) or longer. When the engine speed and the sensor detection values of the determination-target outboard motor 60 are within the normal ranges for a half year or longer, the transmission timing update instruction section 12 advances the processing to STEP S55. When the engine speed and the sensor detection values of the determination-target outboard motor 60 deviate from the normal ranges within a half year, the transmission timing update instruction section 12 advances the processing to STEP S60.

In STEP S55, the transmission timing update instruction section 12 determines the update condition that lengthens an interval (for example, 10 seconds→30 seconds) between transmissions of the work machine information Sti, the update condition being a condition for updating the timings of transmission in a case of treating the outboard motor 60 as one in a state not to be monitored (in scarce need of monitoring). In subsequent STEP S56, the transmission timing update instruction section 12 records the determined update condition in the update condition data 23 of the memory 20.

In STEP S60, the transmission timing update instruction section 12 determines the update condition that shortens the interval (for example, 10 seconds→5 seconds) between transmissions of the work machine information Sti, the update condition being a condition for updating the timings of transmission in a case of treating the outboard motor 60 as one in a state to be monitored (in great need of monitoring), and advances the processing to STEP S56.

The update condition thus recorded in the update condition data 23 of the memory 20 is transmitted from the server 5 to the control unit 70 through the above-described processing in STEPs S1 to S3 and STEPs S40 to S41 in FIG. 3, and the timings of transmission of the work machine information Sti at the control unit 70 are updated according to the update condition. As described above, the interval between transmissions of the work machine information Sti is made shorter for the outboard motor 60 to be monitored, and the interval between transmissions of the work machine information Sti is made longer for the outboard motor 60 not to be monitored, whereby the loads on the server 5 of receiving the work machine information Sti can be reduced in total, and occurrence of a situation can be restrained where the work machine information from the outboard motor 60 to be monitored is not received.

### 5. Other Embodiments

Although the control units 70a to 70c respectively included in the outboard motors 60a to 60c are illustrated as the control unit of the present invention in the above-described embodiment, the present invention can be applied to control units included in various work machines, such as a lawnmower, a tiller, a snowblower, and an electric cart. Moreover, although the communication system 1 including the three control units 70a to 70c is illustrated in FIG. 1, the present invention can also be applied to a communication system including one control unit, or four or more control units.

In STEP S55 in FIG. 5, after the timings of transmission are updated according to the update condition that lengthens the interval between transmissions of the work machine information Sti, the interval between transmissions of the work machine information Sti may be shortened when the number of control units that transmit the work machine information Sti to the server 5 decreases to become equal to or smaller than a predetermined number and consequently the loads on the server 5 of receiving the work machine information Sti are reduced. With such a configuration, when there is room for the loads of receiving on the server, an effect of monitoring the outboard motor 60 can be enhanced by shortening the interval between transmissions of the work machine information Sti.

Although the update condition for the timings of transmission of the work machine information Sti at the control unit 70 is determined by the transmission timing update instruction section 12 included in the server 5 in the above-described embodiment, a configuration may be made such that the update condition for the timings of transmission of the work machine information Sti is determined on a control unit 70 side used in the outboard motor 60. In such a case, the transmission timing update section 83 determines the update condition for the timings of transmission of the work machine information Sti, based on the work machine information on the outboard motor 60 acquired by the work machine information acquisition section 81, and updates the timings of transmission, according to the update condition.

Note that FIG. 2 is a schematic diagram showing functional components of the server 5 and the control unit 70, which are sectioned based on main processing contents in order to facilitate understanding of the invention of the present application, and components of the server 5 and the control unit 70 may be configured based on other sections. Processing by each constituent element may be performed by a single hardware unit, or may be performed by a plurality of hardware units. Processing by each constituent element may be performed by a single program, or may be performed by a plurality of programs.

### REFERENCE SIGNS LIST

1 . . . communication system, 5 . . . server, 10 . . . CPU, 11 . . . work machine information reception section, 12 . . . transmission timing update instruction section, 13 . . . outboard motor monitoring section, 20 . . . memory, 21 . . . control program, 22 . . . work machine information data, 23 . . . transmission timing update condition data, 30 . . . communication unit, 50 (50a, 50b, 50c) . . . vessel, 60 (60a, 60b, 60c) . . . outboard motor, 70 (70a, 70b, 70c) . . . control unit, 80 . . . CPU, 81 . . . work machine information acquisition section, 82 . . . work machine information transmission section, 83 . . . transmission timing update section, 90 . . . memory, 91 . . . control program, 92 . . . work machine information data, 93 . . . unsuccessfully transmitted work machine information data, 100 . . . TCU, 102 . . . GPS unit, 200 . . . communication network, 250 . . . wireless base station.

1. A communication system, comprising:
a server; and
a control unit including a work machine information acquisition section and a work machine information transmission section, the work machine information acquisition section being configured to acquire work machine information that is information related to a work machine, and the work machine information transmission section being configured to transmit the work machine information to the server at a predetermined transmission timing,
wherein the server includes a transmission timing update instruction section configured to transmit, to the control unit, transmission tinning update information that instructs an update of the transmission timing, according to an update condition determined based on the work machine information received from the control unit, and
the control unit includes a transmission timing update section configured to update the transmission timing, based on the transmission timing update information received from the server.

2. The communication system according to claim 1, wherein when transmission of the work machine information to the server at the transmission timing fails, the work machine information transmission section is configured to store the unsuccessfully transmitted work machine information in a memory, and to transmit the work machine information stored in the memory to the server at a timing different from the transmission timing.

3. The communication system according to claim 1, wherein the transmission timing update instruction section is configured to determine, based on the work machine information, whether or not the work machine is in a state to be monitored and, when it is determined that the work machine is in the state to be monitored, to determine the update condition that shortens an interval between transmissions of the work machine information.

4. The communication system according to claim 3, wherein the transmission timing update instruction section is configured to identify an operation condition at a time of normal operation of the work machine, based on the work machine information received during a predetermined time period, and to determine that the work machine that transmits the work machine information is in the state to be, monitored if the work machine is recognized to deviate from the operation condition.

5. The communication system according to claim 1, wherein the transmission timing update instruction section is configured to determine, based on the work machine information, whether or not the work machine is in a state not to be monitored and, when it is determined that the work machine is in the state not to be monitored, to determine the update condition that lengthens an interval between transmissions of the work machine information.

6. The communication system according to claim 5, wherein when the number of the control units that transmit the work machine information decreases to become equal to or smaller than a predetermined number, the transmission timing update instruction section is configured to determine the update condition that shortens the lengthened interval between transmissions of the work machine information.

7. A server that receives work machine information that is information related to a work machine, the work machine information being transmitted at a predetermined transmission timing from a control unit used at the work machine, the server comprising:
a transmission timing update instruction section configured to transmit, to the control unit, transmission timing update information that instructs an update of the transmission timing, according to an update condition determined based on the work machine information transmitted from the control unit.

8. A control unit that includes a work machine information acquisition section and a work machine information transmission section, the work machine information acquisition section being configured to acquire work machine information that is information related to a work machine, and the work machine information transmission section being configured to transmit the work machine information to a server at a predetermined transmission timing, the control unit comprising:
a transmission timing update section configured to update the transmission timing, according to an update condition determined based on the work machine information.

9. The communication system according to claim 2, wherein the transmission timing update instruction section is configured to determine, based on the work machine information, whether or not the work machine is in a state to be monitored and, when it is determined that the work machine is in the state to be monitored, to determine the update condition that shortens an interval between transmissions of the work machine information.

10. The communication system according to claim 9, wherein the transmission timing update instruction section is configured to identify an operation condition at a time of normal operation of the work machine, based on the work machine information received during a predetermined time period, and to determine that the work machine that transmits the work machine information is in the state to be monitored if the work machine is recognized to deviate from the operation condition.

11. The communication system according to claim 2, wherein the transmission timing update instruction section is configured to determine, based on the work machine information, whether or not the work machine is in a state not to be monitored and, when it is determined that the work machine is in the state not to be monitored, to determine the update condition that lengthens an interval between transmissions of the work machine information.

12. The communication system according to claim 3, wherein the transmission timing update instruction section is configured to determine, based on the work machine information, whether or not the work machine is in a state not to be monitored and, when it is determined that the work machine is in the state not to be monitored, to determine the update condition that lengthens an interval between transmissions of the work machine information.

13. The communication system according to claim 4, wherein the transmission timing update instruction section is configured to determine, based on the work machine information, whether or not the work machine is in a state not to be monitored and, when itis determined that the work machine is in the state not to be monitored, to determine the update condition that lengthens an interval between transmissions of the work machine information.

14. The communication system according to claim 9, wherein the transmission timing update instruction section is configured to determine based on the work machine information, whether or not the work machine is in a state not to be monitored and, when it is determined that the work machine is in the state not to be monitored, to determine the update condition that lengthens an interval between transmissions of the work machine information.

15. The communication system according to claim 10, wherein the transmission timing update instruction section is configured to determine, based on the work machine information, whether or not the work machine is in a state not to be monitored and, when it is determined that the work machine is in the state not to be monitored, to determine the update condition that lengthens an interval between transmissions of the work machine information.
